(19) United States
(12) Patent Application Publication
(10) Pub. No.: US 2008/0282290 A1
(43) Pub. Date: Nov. 13, 2008

(54) Interactive Viewer for Advertisements

(75) Inventors: Mansoor Malik, Kirkland, WA (US); Scott Tomlin, Bellevue, WA (US); Phani Vaddadi, Issaquah, WA (US); Mark Masterson, Seattle, WA (US); Tarek Najm, Kirkland, WA (US); Ying Li, Bellevue, WA (US); Raxit Kagalwala, Issaquah, WA (US); Kevin Riedy, Seattle, WA (US); Li Li, Issaquah, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/745,758

(22) Filed: May 8, 2007

(51) Int. Cl. H04N 7/10

(52) U.S. Cl. 725/42

(57) ABSTRACT

A system, method, and computer-readable media are presented for displaying an interactive viewer associated with an advertisement within a user interface. In one aspect, the system includes an advertisement manager for providing advertisements in response to request from clients. The system further includes a rendering component for determining if an advertisement has an associated interactive viewer, determining features associated with the advertisement, and displaying the interactive viewer including the determined features. Additionally, the system includes an event tracking module for monitoring a user's interaction with the interactive viewer, and reporting feedback regarding the interaction to the advertisement manager.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

Internet advertising has become an effective avenue for advertisers to market their products and services to consumers. Advertisers commonly vie for ad space on websites they believe their target market group frequently visits. Additionally, some advertisers may choose to bid on search engine search terms so that their advertisements will appear on search results pages related to a purchased search term.

Internet advertisements may generally be presented in two forms: a display advertisement, which may be a banner advertisement that includes image or video data displayed an allocated space on a web page; or the advertisement may be in the form of a text advertisement. Advertisers may prefer to use display advertisements since such advertisements can offer a richer experience that attracts more users. However, many advertisements on web pages are limited to text advertisements primarily because the entities managing the web sites are concerned that the display advertisements may cause too much clutter and distraction within a user interface (UI). For example, an entity managing a search engine website may not display image or video advertisements on its search results page because such advertisements may distract users from the search results. Accordingly, text advertisements are usually preferred as they are simple and take up less space than display advertisements.

However, the limited use of rich media advertisements may be detrimental to advertisers as there is a potential that fewer users will access textual advertisements. Indeed, the use of rich media advertisements within web pages, if used appropriately, can be a great benefit to advertisers. Therefore, there is a need for less intrusive ways to display rich media advertisements that benefit both advertisers and entities managing web pages.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system, method, and computer-readable media are presented for displaying an interactive viewer associated with an advertisement within a user interface. In one aspect, the method includes retrieving an advertisement and determining if the advertisement has an associated interactive viewer. The interactive viewer is configured to display features associated with the advertisement. The method further includes determining the features that are associated with the advertisement in instances where the advertisement indeed has an associated interactive viewer. The method additionally includes displaying the advertisement and displaying the interactive viewer in a user interface. The displayed interactive viewer will include the determined features of the advertisement.

### BRIEF DESCRIPTION OF THE DRAWINGS

Illustrative embodiments of the present invention are described in detail below with reference to the attached drawing figures, which are incorporated by reference herein and wherein:

FIG. 1 is a block diagram of an exemplary network environment for implementing an embodiment of the present invention.

FIG. 2 is a block diagram of an embodiment of an exemplary system for implementing the an embodiment of the present invention.

FIG. 3A is an embodiment of an exemplary interactive viewer in accordance with an embodiment of the present invention.

FIG. 3B is another embodiment of an exemplary interactive viewer in accordance with an embodiment of the present invention.

FIG. 4 is a flow diagram of an embodiment of an exemplary method for displaying an interactive viewer associated with an advertisement in accordance with an embodiment of the present invention.

FIG. 5 is a flow diagram of an exemplary method for obtaining user feedback regarding an advertisement and/or an interactive viewer in accordance with an embodiment of the present invention.

### DETAILED DESCRIPTION

The invention introduces an interactive viewer that can be displayed along with an advertisement. The interactive viewer is configured to display many more features of an advertisement that are not included within the actual advertisement. Generally, a feature may be an attribute of the advertisement or an action related to the advertisement that is not included within the actual advertisement. The features may include rich multimedia data such as video or image content related to the advertisement. The interactive viewer is configured to be a less intrusive aspect of a user interface (UI) as, in one embodiment, the interactive viewer is only displayed upon the detection of a user-action that requests the interactive viewer.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In one embodiment, the present invention takes the form of a computer-program product that includes computer-useable instructions embodied on one or more computer-readable media.

Computer-readable media include both volatile and nonvolatile media, removable and nonremovable media, and contemplates media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. An exemplary modulated data signal includes a carrier wave or other transport mechanism. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

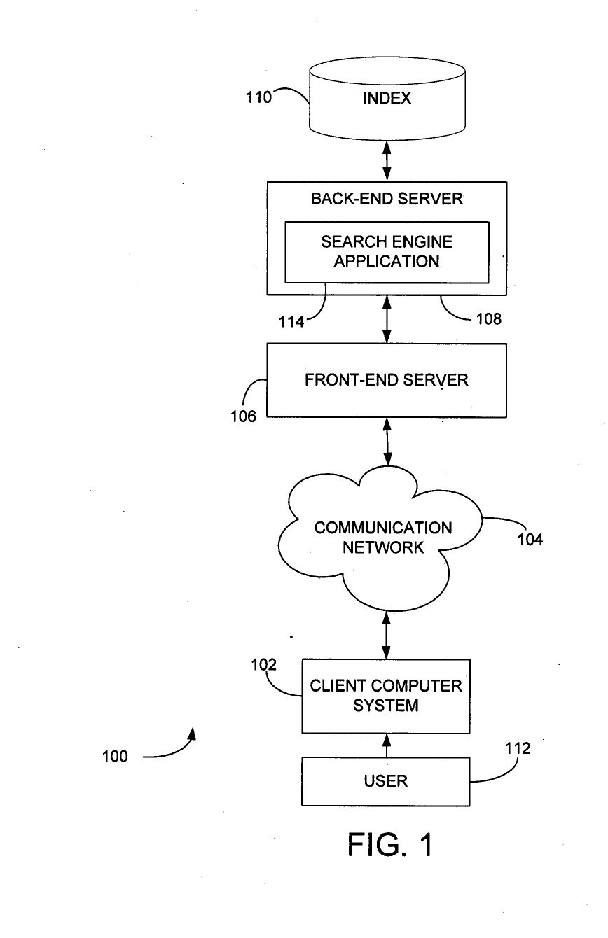

Referring initially to FIG. 1, a block diagram of an exemplary network environment for implementing an embodiment of the present invention is shown and designated generally as network environment 100. Network environment 100 is but one example of a suitable environment and is not intended to suggest any limitation as to the scope of use or functionality of the invention. Neither should the network environment 100 be interpreted as having any dependency or requirement relating to any one or combination of elements illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, specialty computing devices, servers, etc. The invention may also be practiced in distributed computing environments where tasks are performed by remote-processing devices that are linked through a communications network.

Network environment 100 includes a client 102 coupled to a network 104 via a communication interface. The communication interface may be an interface that can allow the client to be directly connected to any other device or allows the client 102 to be connected to a device over network 104. Network 104 can include, for example, a local area network (LAN), a wide area network (WAN), or the Internet (or the World Wide Web). In an embodiment, the client 102 can be connected to another device via a wireless interface through a wireless network 104.

One or more servers communicate with the client 102 via the network 104 using a protocol such as Hypertext Transfer Protocol (HTTP), a protocol commonly used on the Internet to exchange information. In the illustrated embodiment, a front-end server 106 and a back-end server 108 (e.g., web server or network server) are coupled to the network 104. The client 102 employs the network 104, the front-end server 106, and the back-end server 108 to access Web page data stored, for example, in a central data index (index) 110.

Embodiments of the invention provide searching for relevant data by permitting search results to be displayed to a user 112 in response to a user-specified search request (e.g., a search query). In one embodiment, the user 112 uses the client 102 to input a search request including one or more terms concerning a particular topic of interest for which the user 112 would like to identify relevant electronic documents (e.g., Web pages). For example, the front-end server 106 may be responsive to the client 102 for authenticating the user 112 and redirecting the request from the user 112 to the back-end server 108.

The back-end server 108 may process a submitted query using the index 110. In this manner, the back-end server 108 may retrieve data for electronic documents (i.e., search results) that may be relevant to the user. The index 110 contains information regarding electronic documents such as Web pages available via the Internet. Further, the index 110 may include a variety of other data associated with the electronic documents such as location (e.g., links, or URLs), metatags, text, and document category. In the example of FIG. 1, the network is described in the context of dispersing search results and displaying the dispersed search results to the user 112 via the client 102. Notably, although the front-end server 106 and the back-end server 108 are described as different components, it is to be understood that a single server could perform the functions of both.

A search engine application (application) 114 is executed by the back-end server 108 to identify web pages and the like (i.e., electronic documents) in response to the search request received from the client 102. More specifically, the application 114 identifies relevant documents from the index 110 that correspond to the one or more terms included in the search request and selects the most relevant web pages to be displayed to the user 112 via the client 102.

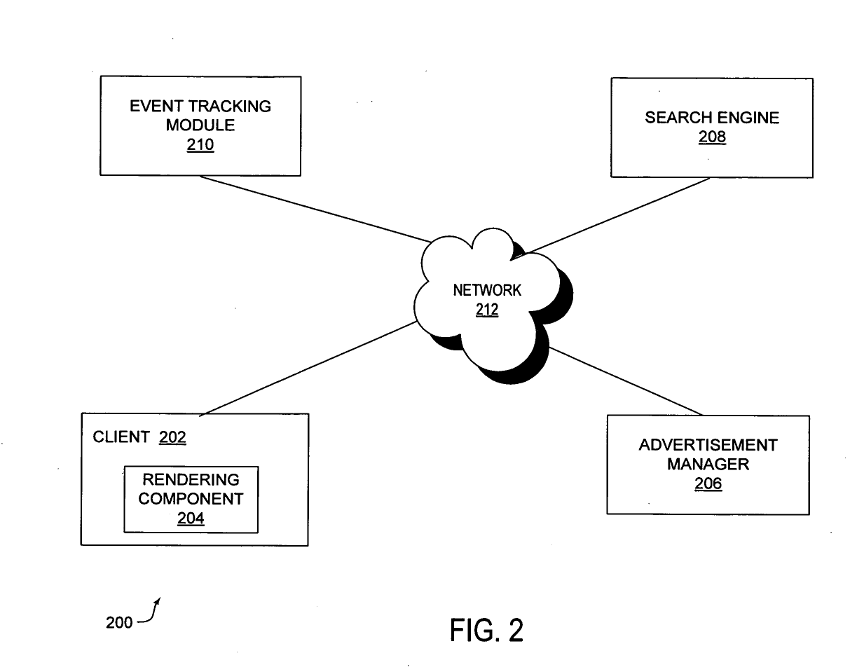

FIG. 2 is a block diagram of an embodiment of an exemplary system 200 for implementing an embodiment of the present invention. The system 200 includes devices such as client 202, advertisement manager 206, search engine 208, event tracking module 210, and network 212. Each device includes a communication interface. The communication interface may be an interface that can allow a device to be directly connected to any other device or allows the device to be connected to another device over network 212. Network 212 can include, for example, a local area network (LAN), a wide area network (WAN), or the Internet. In an embodiment, a device can be connected to another device via a wireless interface through a wireless network 212.

Client 202 may be or can include a desktop or laptop computer, a Digital Video Recorder (DVR), a cable television receiver, a satellite television receiver, a video gaming console, a network-enabled cellular telephone (with or without media capturing/playback capabilities), wireless email client, or other client, machine, or device to perform various tasks including Web browsing, search, electronic mail (email) and other tasks, applications and functions. Client 202 may additionally be any portable media device such as digital still camera devices, digital video cameras (with or without still image capture functionality), media players such as personal music players and personal video players, and any other portable media device. In addition to advertisement manager 206 and event tracking module 210, client 202 may be or can include a server such as a workstation running the Microsoft Windows®, MacOS™, Unix™, Linux, Xenix™, IBM AIX™, Hewlett-Packard UX™, Novell Netware™, Sun Microsystems Solaris™, OS/2™, BeOS™, Mach™, Apache™, OpenStep™ or other operating system or platform.

Client 202 may also include rendering component 204. Rendering component 204 can include an application program interface (API) used to retrieve requested advertisements from advertisement manager 206. As shown, rendering component 204 is within client 202, however, in other embodiments, rendering component 204 may be external to client 202 and may still maintain communication with client 202. In an embodiment, the advertisements are requested by applications executed on client 202. Such applications can make a call to rendering component 204 to retrieve one or more desired advertisements from advertisement manager 206. For example, a web browser running on client 202 may make a call to the rendering component 204 for certain advertisements that are to be displayed on a web page accessed by a user of client 202. Such a web page may be, for example, a search results web page of search engine 208. In an embodiment, the call may include identifiers that designate the particular advertisement that are being requested. The call may also include the location of the advertisement managers 206 that are storing the requested advertisements. In other embodiments, the rendering component 204 may have access to a look-up table that can identify the location of the advertisement manager based on the identifiers of the requested advertisements. Once the location of the advertisements is known, the rendering component 204 can proceed to retrieve the requested advertisements.

Advertisement manager 206 is configured to store a variety of advertisements. For each advertisement, the advertisement manager 206 can store the advertisement's layout information and content information. The layout information can include data pertaining to, but not limited to, the size of the advertisement (height and width), the type of advertisement, an identifier that identifies the particular advertisement (AdID), information that indicates that the advertisement has an interactive viewer that can be displayed with it, information regarding the different features that can be displayed in the interactive viewer, and information detailing how the interactive viewer should be rendered within a UI of the client device. The content information includes the multimedia data of the advertisement that will be displayed to the user. The advertisement manager 206 is configured to merge the content information with the layout information when it receives a request to provide an advertisement.

Once the content information has been merged with the layout information, the advertisement manager 206 can provide the advertisement to the rendering component 204. The rendering component can then interrogate the layout and/or content information of the advertisement to determine if the advertisement has an interactive viewer that can be displayed with it. If the advertisement indeed has an interactive viewer associated with it, the rendering component 204 can further interrogate the advertisement to determine what features should be displayed in the interactive viewer.

After the rendering component 204 interrogates the advertisement, the rendering component 204 can then display the advertisement within a user interface employed by the requesting application. In an embodiment, the rendering component 204 will display the interactive viewer at the same time it displays the advertisement in the user interface. In another embodiment, the rendering component can display the interactive viewer upon detecting an action from a user after the rendering component displays the advertisement within the user interface. For example, the user may request to be presented with the interactive viewer by executing one of the following actions: hovering a mouse cursor over the displayed advertisement; hovering a mouse cursor over an icon associated with the displayed advertisement; clicking the displayed advertisement with a mouse cursor; clicking an icon associated with the displayed advertisement with a mouse cursor; using an input device to access the displayed advertisement; or using an input device to access an icon associated with the displayed advertisement. Once a user-action has been detected, the rendering component 204 can display the interactive viewer with the advertisement within the UI. The user may then choose to select a feature listed in the interactive viewer. Once the user selects a feature, the rendering component 204 can invoke the appropriate application to run the selected feature. For example, if the user selects a feature for emailing advertisement to a friend, the rendering component 204 can open an email application to forward the advertisement to the friend. In another example, the user may choose to select a feature for chatting with a representative of the sponsor of the advertisement. In such an example, the rendering component 204 may initiate a chat session with the representative.

Event tracking module 210 is configured to monitor a user's interaction with either an advertisement and/or an interactive viewer, and is further utilized to report feedback regarding the interaction to advertisement manager 206. As shown, event tracking module 210 is external to the client 202, however, in other embodiments, the event tracking module 210 may be a component within client 202 or within a third-party server such as search engine 208 or advertisement manager 206. The event tracking module 210 can monitor the user interaction in order to obtain user feedback which can be used to evaluate the advertisement or the interactive viewer. Such feedback may be active or passive.

Active feedback is when the user explicitly takes action to provide feedback that describes the user's thoughts regarding the effectiveness, performance, or satisfaction with either the advertisement or the interactive viewer. There may be multiple different feedback inputs available to the user that will allow the user to input his/her feedback of the advertisement and/or the interactive viewer. For example, one feedback input available to the user may be an option to fill-out a feedback form within a user interface (UI) of client 202 where the user can freely type-in his/her thoughts about the advertisement and/or interactive viewer. Another feedback input may be an option to rate the advertisement and/or interactive viewer using a predefined rating system. For example, the user may be presented with a UI in which the user can provide feedback by rating the advertisement and/or interactive viewer on a numeric scale, 1-5 for example, wherein 5 could be the most favorable rating and 1 could be the least favorable rating. Another example could be presenting a UI to the user in which the user can select from any number predefined textual descriptions that can be used to rate the advertisement and/or interactive viewer. For example, the UI may contain such terms as “extremely useful,” “useful,” “somewhat useful,” and “not useful at all” that the user can select as feedback regarding a particular advertisement and/or interactive viewer. In an embodiment, the option to enter active feedback can be a selectable feature of the interactive viewer.

Passive feedback also involves a user's interaction with an advertisement and/or an interactive viewer. With passive feedback, a user gives insight to his/her thoughts regarding the effectiveness, performance, or satisfaction with either the advertisement or the interactive viewer without the user explicitly stating his/her thoughts. Some examples of different passive feedback metrics that can be used to determine a user's thoughts of an advertisement and/or interactive viewer can include: whether the user selects the advertisement and/or interactive viewer; the amount of time the user spends interacting with the advertisement and/or interactive viewer; the amount of time a user spends on an advertiser's web page when directed to the page after selecting the advertisement or interactive viewer; the types of features of the interactive viewer that the user selects; and the amount of time the user interacts with certain features of the interactive viewer.

Once feedback, either active or passive, has been compiled, the event tracking monitor 210 can transmit the feedback to advertisement manager 206. An administrator of advertisement manager 206 can review the feedback to determine if any changes should be made to the advertisement or the interactive viewer. In one instance, the administrator may determine to replace or modify the advertisement or the interactive viewer. Alternatively, the administrator may determine that the feedback is favorable and may decide not to replace or modify the advertisement or interactive viewer.

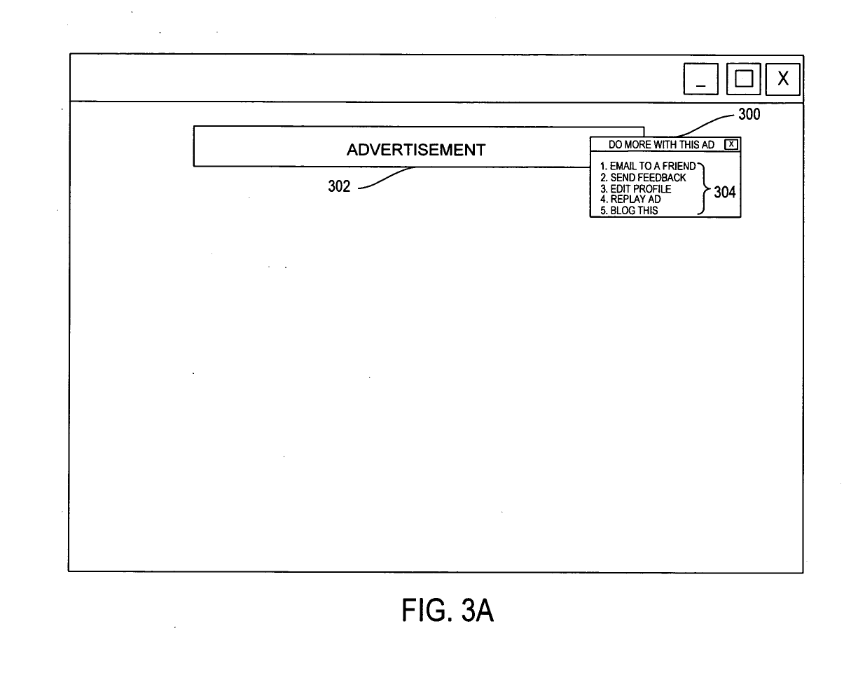

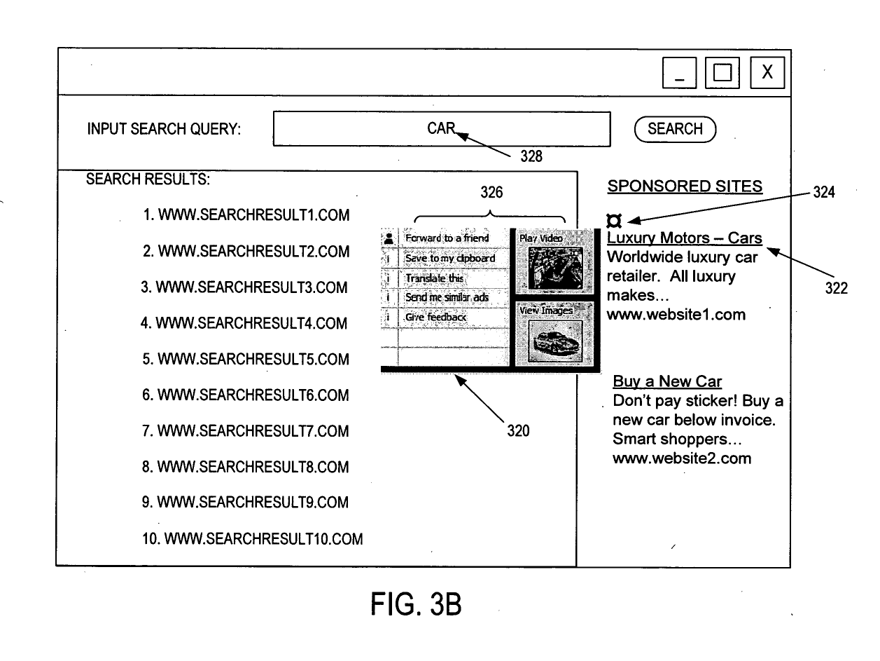

FIG. 3A is an embodiment of an exemplary interactive viewer 300 in accordance with an embodiment of the present invention. Advertisement 302 is a display advertisement such as a banner ad. Interactive viewer 300 includes features 304 related to advertisement 302. As shown, such features can include emailing the advertisement to a friend, sending feedback regarding the advertisement or the interactive viewer, editing a profile related to the advertisement, replaying the advertisement, and blogging the advertisement. However, the preceding features are examples of the types of features that can be incorporated into an interactive viewer, and the invention should not be limited to only those examples. A user can choose to select any number of features of interest. In an embodiment, the interactive viewer 300 may be displayed at the same time as the advertisement 302. In another embodiment, the interactive viewer 300 is displayed after the advertisement 302 when the user takes action to request the interactive viewer. Once a user selects a feature, a rendering component can invoke an appropriate application to run the selected feature.

FIG. 3B is another embodiment of an exemplary interactive viewer 320 in accordance with an embodiment of the present invention. In FIG. 3B, interactive viewer 320 is associated with a text advertisement 322 on a search results page, wherein the text advertisement 322 is presented based on the search query 328 inputted by a user. In FIG. 3B, interactive viewer 320 is displayed by a user accessing icon 324 after the advertisement 322 is displayed. The icon 324 may be accessed in a number of ways including, but not limited to, a user clicking the icon 324 with a mouse cursor, a user hovering a mouse cursor over the icon, or a user touching the icon 324 in instances where the UI displaying the search results page is displayed on a client device that includes a touch-screen. In other embodiments, other input devices may be used to access icon 324.

Once icon 324 has been accessed, the interactive viewer 320 is presented. The interactive viewer may be presented by a rendering component of the client device that is presenting the UI including the search results page. As shown, the interactive viewer 320 includes many features 326 related to the advertisement 322. Such features include: forwarding the advertisement to a friend, saving the advertisement to a clipboard, translating the advertisement into a different language, sending similar advertisements to the user, providing feedback about the advertisement, playing a video clip associated with the advertisement, and viewing images associated with the advertisement. However, the preceding features are examples of the types of features that can be incorporated into an interactive viewer, and the invention should not be limited to only those examples. Again, a feature can be any attribute of an advertisement or action that can be taken related to the advertisement that is not included within the actual advertisement. Once a user selects a feature, a rendering component can invoke an appropriate application to run the selected feature.

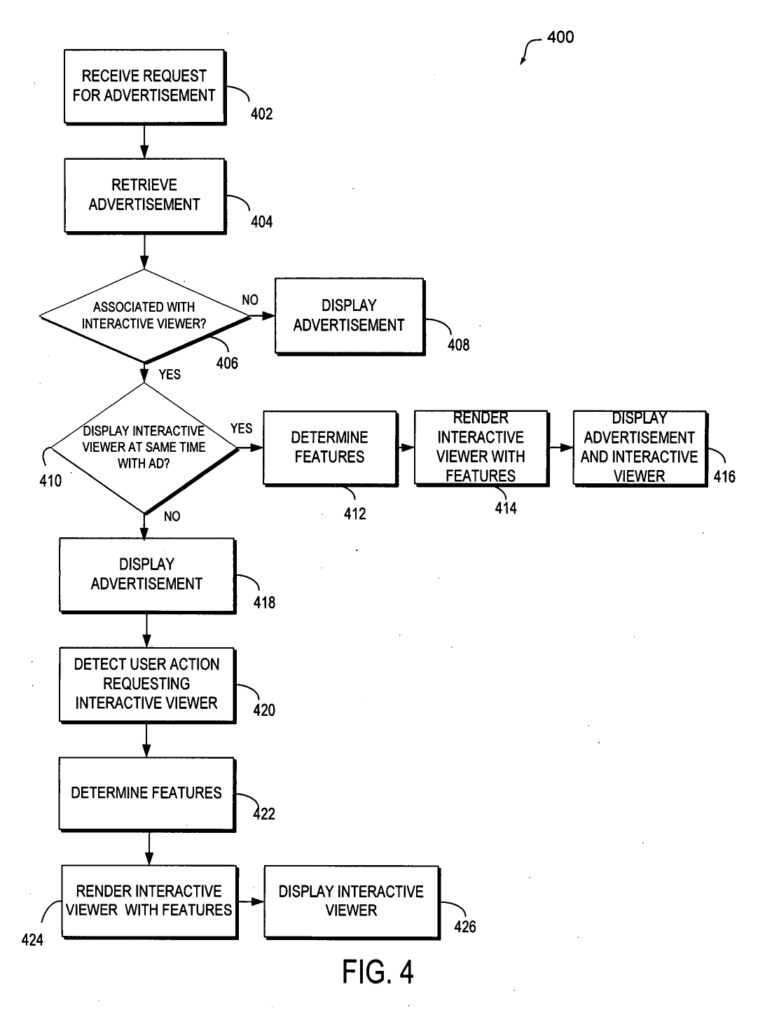

FIG. 4 is a flow diagram of an embodiment of an exemplary method 400 for displaying an interactive viewer associated with an advertisement in accordance with an embodiment of the present invention. At operation 402, a request is received for an advertisement. In an embodiment, the request is received by a rendering component from an application on a client device. At operation 404, the advertisement is retrieved. In an embodiment, the advertisement may be retrieved by the rendering component from an advertisement manager. At operation 406, a determination is made as to whether the advertisement has an interactive viewer that can be displayed with it. In an embodiment, the determination can be made by the rendering component interrogating the layout information and/or the content information of the advertisement. In such an embodiment, the layout information and/or the content information will contain data informing the rendering component if an interactive viewer can be displayed with the advertisement. If it is determined that the advertisement does not have an interactive viewer associated with it, the advertisement can be displayed in the UI of the client at operation 408. If it is determined that the advertisement has an interactive viewer associated with it, then a determination can be made at operation 410 as to whether to display the interactive viewer at the same time as the advertisement. In an embodiment, the determination can be made by the rendering component interrogating the layout information and/or the content information of the advertisement. In such an embodiment, the layout information and/or the content information will contain data informing the rendering component if an interactive viewer should be displayed at the same time as the advertisement. In another embodiment, the rendering component can be configured to automatically display the interactive viewer at the same time as the advertisement.

If it is determined that the interactive viewer should be displayed at the same time as the advertisement, a determination is made as to what features should be included in the interactive viewer at operation 412. In an embodiment, the determination can be made by the rendering component interrogating the layout information and/or the content information of the advertisement. In such an embodiment, the layout information and/or the content information will contain data informing the rendering component of the types of features that should be included in the interactive viewer. At operation 414, the interactive viewer is rendered according to the features determined to be included within the interactive viewer. At operation 416, the advertisement and interactive viewer are displayed within a UI of a client device.

However, at operation 410, it may be determined that the interactive viewer should not be displayed at the same time as the advertisement. Again, in an embodiment, the determination can be made by the rendering component interrogating the layout information and/or the content information of the advertisement. In such an embodiment, the layout information and/or the content information will contain data informing the rendering component that the interactive viewer should not be displayed at the same time as the advertisement. In another embodiment, the rendering component can be configured to automatically display the advertisement first without displaying the interactive viewer.

At operation 418, the advertisement is displayed. At operation 420, a user action is detected requesting the interactive viewer associated with the advertisement. At operation 422, a determination is made as to what features should be included in the interactive viewer. In an embodiment, the determination can be made by the rendering component interrogating the layout information and/or the content information of the advertisement. In such an embodiment, the layout information and/or the content information will contain data informing the rendering component of the types of features that should be included in the interactive viewer. At operation 424, the interactive viewer is rendered according to the features determined to be included within the interactive viewer. At operation 426, the interactive viewer is displayed within a UI of a client device.

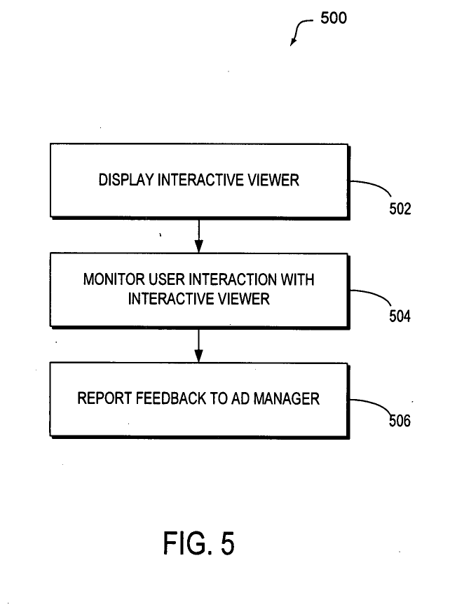

FIG. 5 is a flow diagram of an exemplary method 500 for obtaining user feedback regarding an advertisement and/or an interactive viewer in accordance with an embodiment of the present invention. At operation 502, an interactive viewer is displayed within an UI of a client device. At operation 504, user interaction with the interactive viewer is monitored. The user interaction monitored can result in active or passive feedback being provided by a user. The feedback can give insight to a user's thoughts regarding the effectiveness, performance, or satisfaction with either the advertisement or the interactive viewer. At operation 506, the feedback is reported to an advertisement manager. With the feedback, an administrator of the advertisement manager may decide to either replace or modify aspects of either the advertisement or interactive viewer. Alternatively, the administrator may determine that the feedback is favorable and may decide not to replace or modify the advertisement or interactive viewer.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

We claim:

1. One or more computer-readable media having computer-usable instructions stored thereon for performing a method for displaying an interactive viewer associated with an advertisement, the method comprising:
retrieving an advertisement;
determining if the advertisement has an associated interactive viewer, the interactive viewer being configured to display one or more features associated with the advertisement;
displaying the advertisement; and
displaying the interactive viewer, the interactive viewer including the one or more determined features.

2. The computer-readable media according to claim 1, wherein the interactive viewer is displayed when the advertisement is displayed.

3. The computer-readable media according to claim 1, wherein the interactive viewer is displayed when a user takes action with respect to the displayed advertisement.

4. The computer-readable media according to claim 3, wherein taking action with respect to the displayed advertisement comprises at least one of: hovering a mouse cursor over the displayed advertisement, hovering a mouse cursor over an icon associated with the displayed advertisement, clicking the displayed advertisement with a mouse cursor, clicking an icon associated with the displayed advertisement with a mouse cursor, using an input device to access the displayed advertisement, and using an input device to access an icon associated with the displayed advertisement.

5. The computer-readable media according to claim 1, wherein the method further comprises invoking an application to run a selected feature of the one or more determined features.

6. The computer-readable media according to claim 1, wherein the method further comprises monitoring a user's interaction with the interactive viewer.

7. The computer-readable media according to claim 6, further comprising reporting the user's interaction to an advertisement manager.

8. A computer-implemented method for reporting feedback corresponding to a user's interaction with an interactive viewer, comprising
displaying an interactive viewer associated with an advertisement, the interactive viewer including one or more features associated with the advertisement;
monitoring one or more users' interaction with the interactive viewer; and
reporting the interaction to an advertisement manager.

9. The computer-implemented method according to claim 8, wherein at least one of the advertisement and the interactive viewer is modified based on the reporting of the one or more users' interaction with the interactive viewer.

10. The computer-implemented method according to claim 8, wherein monitoring the one or more users' interaction with the interactive viewer comprises receiving feedback from the one or more users that is used to evaluate at least one of the advertisement and the interactive viewer.

11. The computer-implemented method according to claim 10, wherein the feedback is active feedback received in a feedback form completed by the one or more users.

12. The computer-implemented method according to claim 11, wherein receiving feedback in the feedback form is one of the one or more features.

13. The computer-implemented method according to claim 10, wherein the feedback is passive feedback from the user's interaction with the interactive viewer.

14. The computer-implemented method according to claim 8, wherein the interactive viewer is displayed with the advertisement.

15. A system for displaying an interactive viewer associated with an advertisement, comprising:
an advertisement manager for providing advertisements in response to a request from one or more clients, wherein one or more of the advertisements have an associated interactive viewer, the interactive viewer being configured to display one or more features associated with at least one of the advertisements;
a rendering component for determining if at least one of the one or more advertisements has an associated interactive viewer, determining one or more features associated with at least one of the one or more advertisements, and displaying the interactive viewer, the interactive viewer including the one or more determined features; and
an event tracking module for monitoring one or more users' interaction with the interactive viewer and reporting feedback to the advertisement manager, wherein the feedback corresponds to the interaction.

16. The system according to claim 15, wherein at least one of the one or more advertisements and the interactive viewer are modified based on the reporting of the one or more users' interaction with the interactive viewer to the advertisement manager.

17. The system according to claim 15, wherein the interactive viewer is displayed when a user takes action to a displayed advertisement.

18. The system according to claim 15, wherein the feedback is at least one of active feedback and passive feedback.

19. The system according to claim 15, wherein the determining if at least one of the one or more advertisements has an associated interactive viewer comprises examining content of at least one of the one or more advertisements.

20. The system according to claim 15, wherein the rendering component renders the interactive viewer based on the one or more features associated with at least one of the one or more advertisements.
